(19) United States
(12) Patent Application Publication
(10) Pub. No.: US 2017/0097149 A1
(43) Pub. Date: Apr. 6, 2017

(54) Night Lamp with USB Charging Dock

(71) Applicant: Rich Brand Industries Limited, Dongguan City (CN)

(72) Inventor: Te-Shui Peng, Taoyuan City (TW)

(21) Appl. No.: 14/875,733

(22) Filed: Oct. 6, 2015

(51) Int. Cl. F21V 23/06; F21V 23/04

(52) U.S. Cl. CPC F21V 23/06; F21V 23/0464; F21V 23/04

(57) ABSTRACT

A night lamp with a USB charging dock includes a casing and a printed circuit board and a light emitting element installed in the casing. The printed circuit board comes with a circuit configuration to provide appropriate electrical functions to the light emitting element. The light emitting element receives power and control of the printed circuit board. A USB charging module, a switch and a socket are installed on the casing and receives power and control of the printed circuit board to output a low-voltage direct current to charge a 3 C electronic product. The switch is electrically connected to the printed circuit board for turning on and off the light emitting element. The socket is connected to a power supply to transmit electric power to the printed circuit board. The night lamp has the functions of providing glimmer lighting for nighttime and charging a 3 C electronic product.

### TECHNICAL FIELD

The technical field relates to a night lamp with a universal serial bus (USB) charging dock, and more particularly to the night lamp having the functions of providing glimmer light for nighttime and charging an electronic product through a USB connection.

### BACKGROUND

Lamp is one of the necessary electric appliances in our life and mainly used for providing light, and various common lamps include table lamps, nightlights, fluorescent lamps, etc. Common lamps include table lamps, fluorescent lamps, atmospheric lamps, night lamps, etc. A general night lamp comprises a casing, and a printed circuit board and a light emitting element installed in the casing, and the light emitting element is electrically connected to the printed circuit board. A socket and a switch are installed on a surface of the casing and connected to a power supply (such as the mains power) to transmit electric power to the printed circuit board. When a related circuit configuration of the printed circuit board supplies an electric power with appropriate electrical conditions to the light emitting element, the switch controls and turns on and off the light emitting element. If the switch is set to an ON status, then the light emitting element will be lit, and if switch is set to an OFF status, then the light emitting element will be extinguished. In recent years, science and technology advance, so that some manufacturers have developed a night lamp having an LED light emitting element and mainly changed the related circuit configuration of the printed circuit board to adapt the electric power suitable for the LED light emitting element. Since the LED light emitting element saves power and has a lower light emission temperature, LED night lamp becomes increasingly more popular.

However, the conventional night lamp regardless of having the conventional light emitting element or the LED light emitting element simply has the function of providing glimmer light for nighttime. As technology advances, users require more function of the 3 C electronic products, and thus it is necessary to extend the use of the night lamp, such as a night lamp capable of providing light and other functions to improve the added-on value of the night lamp.

### SUMMARY

Therefore, it is a primary objective of this disclosure to provide a night lamp with a USB charging dock and having the functions of providing glimmer light for nighttime and charging an electronic product through a USB connection.

To achieve the aforementioned and other objectives, this disclosure provide a night lamp with a USB charging dock comprising a casing, and a printed circuit board and a light emitting element installed in the casing, wherein the printed circuit board comes with a necessary related circuit configuration designed thereon to provide appropriate electrical conditions for the light emitting element, and the light emitting element receives power and control of the printed circuit board; and a USB charging module, a switch and a socket installed on a surface of the casing, and the USB charging module receiving power and control of the printed circuit board to output a low-voltage direct current to charge a 3 C electronic product, wherein the switch is electrically coupled to the printed circuit board for controlling and turning on and off the light emitting element; and the socket is connected to a power supply and provided for transmitting electric power to the printed circuit board.

In the night lamp with a USB charging dock, the switch is a photosensitive switch.

In the night lamp with a USB charging dock, the switch is a sensor switch.

In the night lamp with a USB charging dock, the switch is a manual switch.

In the night lamp with a USB charging dock, the light emitting element is a tungsten bulb.

In the night lamp with a USB charging dock, the light emitting element is an LED bulb.

In the night lamp with a USB charging dock, the socket and the casing are combined by locking to facilitate changing an appropriate socket.

### BRIEF DESCRIPTION OF THE DRAWINGS

FIG. 1 is a perspective view of a first preferred embodiment of this disclosure;

FIG. 2 is a front view of the first preferred embodiment of this disclosure;

FIG. 3 is a front view of a second preferred embodiment of this disclosure;

FIG. 4 is a front view of a third preferred embodiment of this disclosure;

FIG. 5 is a perspective view of a fourth preferred embodiment of this disclosure;

FIG. 6 is a front view of the fourth preferred embodiment of this disclosure;

FIG. 7 is a front view of a fifth preferred embodiment of this disclosure; and

FIG. 8 is a front view of a sixth preferred embodiment of this disclosure.

### DETAILED DESCRIPTION OF THE PREFERRED EMBODIMENTS

This disclosure will become clearer in light of the following detailed description of an illustrative embodiment of this invention described in connection with the drawings.

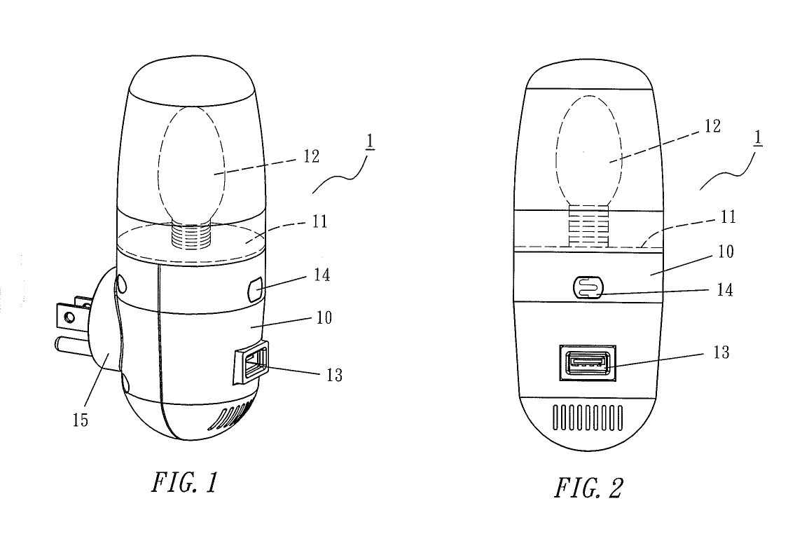

With reference to FIGS. 1 and 2 for a night lamp 1 in accordance with the first preferred embodiment of this disclosure, the night lamp 1 comprises a casing 10, and a printed circuit board 11 and a light emitting element 12 installed in the casing 10, wherein the printed circuit board 11 comes with a necessary related circuit configuration such as a voltage regulation and rectification circuit and/or a necessary voltage conversion circuit to provide appropriate electric conditions for the light emitting element 12, and the light emitting element 12 may be a tungsten bulb and receives power and control of the printed circuit board 11. In addition, a USB charging module 13, a switch 14 and a socket 15 are installed on a surface of the casing 10, wherein the USB charging module 13 receives the power and control of the printed circuit board 11 to output a low-voltage direct current to charge a 3 C electronic product. The switch 14 may be a photosensitive switch electrically coupled to the printed circuit board 11 and provided for controlling and turning on and off the light emitting element 12. The socket 15 and the casing 10 are locked and combined and pins are extended backward to facilitate connecting a connector of a power supply (such as the mains power), so as to transmit electric power to the printed circuit board 11, and a related circuit configuration of the printed circuit board 11 supplies an electric power with appropriate electrical conditions to the light emitting element 12 and the USB charging module 13. Since the socket 15 and the casing 10 are locked and combined with each other, therefore an appropriate socket 15 may be changed at appropriate time for the electric equipment standards of different countries to fit the use for every country in the world.

In the use of the night lamp 1, the switch 14 is provided for controlling and turning on and off the light emitting element 12. If the switch 14 is situated in a dark environment of a predetermined darkness (or in an ON status), then the light emitting element 12 will be lit; and if the switch 14 senses a bright environment with a predetermined brightness (or in an OFF status), then the light emitting element 12 will be extinguished.

On the other hand, the USB charging module 13 is not controlled by the switch 14, but it receives the power and control of the printed circuit board 11 directly to output a low-voltage direct current, so that when it is necessary to charge a 3 C electronic product, a charging cable may be plugged into the USB charging module 13 to obtain current with appropriate electrical condition for the charging.

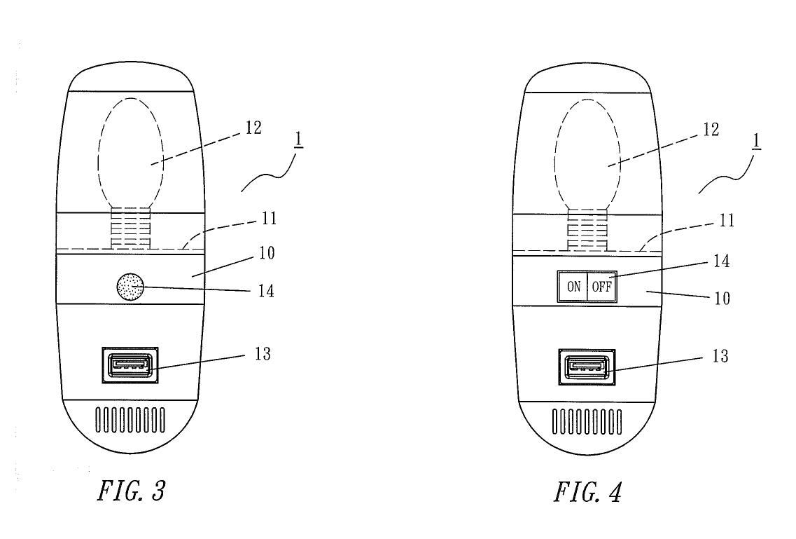

With reference to FIG. 3 for a night lamp 1 in accordance with the second preferred embodiment of this disclosure, the night lamp 1 of the second preferred embodiment is substantially the same as the first preferred embodiment, except that the switch 14 of the second preferred embodiment is a sensor switch. When the switch 14 senses a human body or an object approaching a position of a predetermined distance, the printed circuit board 11 will control the light emitting element 12 to be lit. On the other hand, if the switch 14 does not sense any human body or object approaching a position of a predetermined distance, the light emitting element 12 will not be lit. The structure and function of the USB charging module 13 are the same as those of the first preferred embodiment, and thus will not be repeated.

With reference to FIG. 4 for a night lamp 1 in accordance with the third preferred embodiment of this disclosure, the difference of this preferred embodiment from the first and second preferred embodiments resides on that the switch 14 of the third preferred embodiment is a manual switch. If the manual switch is set to the ON status, then the light emitting element 12 will be lit. On the other hand, if the manual switch is set to the OFF status, then the light emitting element 12 will be extinguished. The structure and function of the third preferred embodiment having the USB charging module 13 are the same as those of the first and second preferred embodiments, and thus will not be repeated.

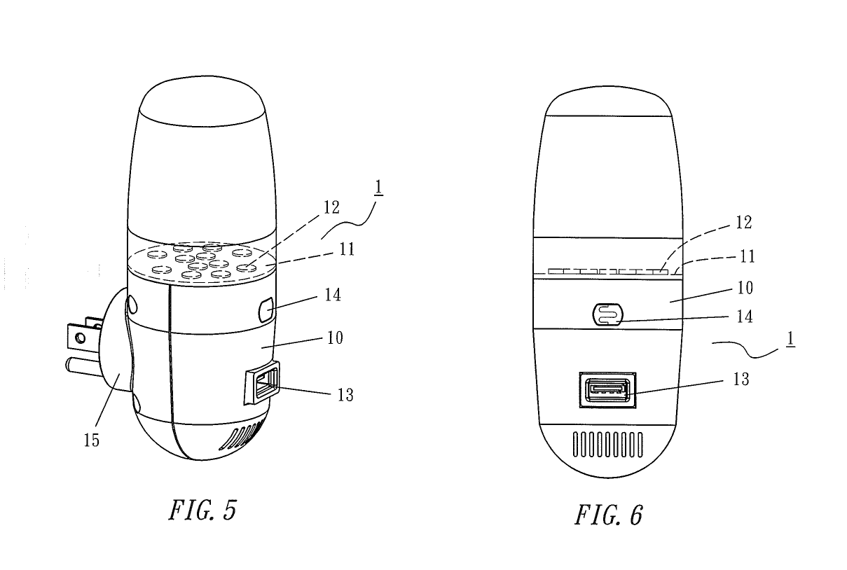

With reference to FIGS. 5 and 6 for a night lamp 1 in accordance with the fourth preferred embodiment of this disclosure, the difference of this preferred embodiment from the first preferred embodiment resides on that the light emitting element 12 of the fourth preferred embodiment is an LED bulb, and the structure and function of the USB charging module 13 and the switch 14 (which is a photosensitive switch) of the fourth preferred embodiment are the same as those of the first preferred embodiment, and thus will not be repeated.

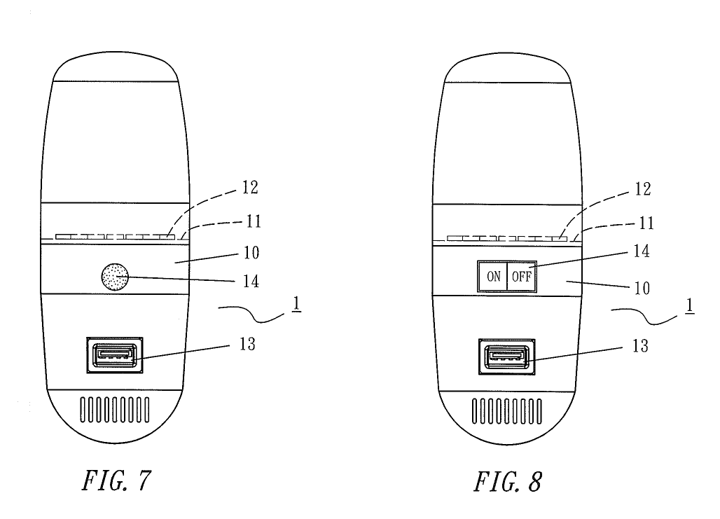

With reference to FIG. 7 for a night lamp 1 in accordance with the fifth preferred embodiment of this disclosure, the night lamp 1 of this preferred embodiment is the same as the second preferred embodiment, except that the light emitting element 12 of the fifth preferred embodiment is an LED bulb. The structure and function of the fifth preferred embodiment having the USB charging module 13 and the switch 14 (which is a sensor switch) are the same as those of the second preferred embodiment, and thus will not be repeated.

With reference to FIG. 8 for a night lamp 1 in accordance with the sixth preferred embodiment of this disclosure, the difference between this preferred embodiment and the third preferred embodiment resides on that the light emitting element 1 of the sixth preferred embodiment is an LED bulb. The structure and function of the sixth preferred embodiment having the USB charging module 13 and the switch 14 (which is a manual switch) are the same as those of the third preferred embodiment, and thus will not be repeated.

From the description above, this disclosure mainly adds the USB charging module 13 to the night lamp 1, such that when a power supply is plugged into the socket 15 of the night lamp 1, the internal printed circuit board 11 supplies power and provides appropriate electrical conditions to the USB charging module 13, so that the USB charging module 13 outputs a low-voltage direct current for charging a 3 C electronic product, so that the light emitting element 12 of the night lamp 1 regardless of being lit or extinguished, the USB charging module 13 may be used for charging a 3 C electronic product. The innovative structure of the night lamp 1 with the USB charging module 13 has both functions of acting as a night lamp 1 to provide light and charging an electronic product, so as to improve the added-on value of the night lamp in the aspects of sales and application significantly.

In summation, this disclosure achieves the expected functions and effects, and the detailed description of the preferred embodiments to enable persons having ordinary skill in the art to implement this disclosure. While this disclosure has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A night lamp with a USB charging dock, comprising a casing, and a printed circuit board and a light emitting element installed in the casing, and the printed circuit board having a necessary related circuit configuration designed thereon to provide appropriate electrical conditions for the light emitting element, and the light emitting element receiving power and control of the printed circuit board; and a USB charging module, a switch and a socket installed on a surface of the casing, and the USB charging module receiving power and control of the printed circuit board to output a low-voltage direct current to charge a 3C electronic product; and the switch being electrically coupled to the printed circuit board for controlling and turning on and off the light emitting element; and the socket being connected to a power supply and provided for transmitting electric power to the printed circuit board.

2. The night lamp with a USB charging dock according to claim 1, wherein the switch is a photosensitive switch.

3. The night lamp with a USB charging dock according to claim 1, wherein the switch is a sensor switch.

4. The night lamp with a USB charging dock according to claim 1, wherein the switch is a manual switch.

5. The night lamp with a USB charging dock according to claim 1, wherein the light emitting element is a tungsten bulb.

6. The night lamp with a USB charging dock according to claim 1, wherein the light emitting element is an LED bulb.

7. The night lamp with a USB charging dock according to claim 1, wherein the socket and the casing are combined by locking to facilitate changing an appropriate socket.
